(19) United States
(12) Patent Application Publication
(10) Pub. No.: US 2017/0105214 A1
(43) Pub. Date: Apr. 13, 2017

(54) WIRELESS COMMUNICATION USING A CHANNEL SCHEDULE

(71) Applicant: Microsoft Technology Licensing, LLC, Redmond, WA (US)

(72) Inventors: David W. Russo, Woodinville, WA (US); Ranveer Chandra, Kirkland, WA (US)

(73) Assignee: Microsoft Technology Licensing, LLC, Redmond, WA (US)

(21) Appl. No.: 14/877,113

(22) Filed: Oct. 7, 2015

(51) Int. Cl. H04W 72/04; H04W 76/02

(52) U.S. Cl. CPC H04W 72/0453; H04W 76/02

(57) ABSTRACT

The disclosed subject matter includes techniques for wireless communication. In one example, a system includes a processor and a computer-readable memory storage device for storing executable instructions that can be executed by the processor to cause the processor to generate a channel hop sequence of wireless channels to be used by an access point. The processor can also send a channel schedule to a client device via a wireless channel. The processor can also change the wireless channel to a next available channel in the channel hop sequence in response to detecting a change in wireless metrics of the wireless channel. The processor can also further receive a connection request from the client device via the next available wireless channel based at least on the channel schedule.

### BACKGROUND

Client devices and access points in a wireless network typically communicate with each other via one or more wireless channels. In some examples, an access point may use different wireless channels to transmit data to a client device at different points in time.

### SUMMARY

The following presents a simplified summary of the innovation in order to provide a basic understanding of some aspects described herein. This summary is not an extensive overview of the disclosed subject matter. It is intended to neither identify key elements of the disclosed subject matter nor delineate the scope of the disclosed subject matter. Its sole purpose is to present some concepts of the disclosed subject matter in a simplified form as a prelude to the more detailed description that is presented later.

An implementation provides for a system for wireless communication. The system can include a processor and a computer-readable memory storage device storing executable instructions that, based on an execution by the processor, can cause the processor to generate a channel hop sequence of wireless channels to be used by an access point. The system can also include instructions to cause the processor to send a beacon including a channel schedule to a client device via a wireless channel. The system can further include instructions to cause the processor to change the wireless channel to a next available channel in the channel hop sequence in response to detecting a change in wireless metrics of the wireless channel. The system can further include instructions to cause the processor to receive a connection request from the client device via the next available wireless channel based at least on the channel schedule.

Another implementation provides a system for wireless communication. The system can include a processor and a computer-readable memory storage device storing executable instructions that, based on an execution by the processor, can cause the processor to receive a first beacon including a channel schedule corresponding to a channel hop sequence from an access point via a first wireless channel. The system can also include instructions to cause the processor to generate a channel hop sequence for the access point based at least on the channel schedule. The system can also include instructions to cause the processor to detect a loss of connection with the access point at the first wireless channel. The system can also include instructions to cause the processor to select a second wireless channel to scan for beacons based at least on the channel schedule and the first wireless channel. The system can also include instructions to cause the processor to detect a second beacon from the access point on the second wireless channel. The system can also include instructions to cause the processor to send a connection request to the access point on the second wireless channel in response to detecting the second beacon.

Another implementation provides for a method for wireless communication. The method can include receiving a beacon including a channel schedule corresponding to a channel hop sequence in a beacon from an access point via a first wireless channel. The apparatus can further include generating a channel hop sequence for the access point based at least on the channel schedule. The method can also include detecting a loss of connection with the access point at the first wireless channel. The method can also further include selecting a second wireless channel to scan for beacons based at least on the channel schedule and the first wireless channel. The method can also include detecting a beacon from the access point on the second wireless channel. The method can further include sending a connection request via the second wireless channel to the access point in response to detecting the beacon.

The following description and the annexed drawings set forth in detail certain illustrative aspects of the disclosed subject matter. These aspects are indicative, however, of a few of the various ways in which the principles of the innovation may be employed and the disclosed subject matter is intended to include all such aspects and their equivalents. Other advantages and novel features of the disclosed subject matter will become apparent from the following detailed description of the innovation when considered in conjunction with the drawings.

### BRIEF DESCRIPTION OF THE DRAWINGS

FIG. 1 is a block diagram of an example operating environment configured for implementing various aspects of the techniques described herein;

FIG. 2 is a timing diagram of an example process for wireless communication using channel schedules;

FIG. 3 is a process flow diagram of an example method for wireless communication using channel schedules;

FIG. 4 is a process flow diagram of another example method for wireless communication using channel schedules;

FIG. 5 is a block diagram of an example system for wireless communication using channel schedules; and

FIG. 6 is a block diagram showing an example tangible, computer-readable storage medium that can be used for wireless communication using channel schedules.

### DETAILED DESCRIPTION

As discussed above, access points may change the wireless channel by which the access points transmit data to client devices. In some examples, an access point may restart or be reset and choose a different wireless channel based on prevailing wireless conditions at the time. In some examples, the access point may change wireless channels for various reasons. For example, an access point may switch from using a 5 GHz channel if a wireless device with a higher priority such as radar is detected in the area. Other forms of interference from competing devices may similarly cause the access point to switch to a different channel.

With the increasing number of wireless channels available, a client device may take a longer amount of time to scan channels in order to discover the new channel that an access point is using to transmit data. For example, the access point may have not been able to notify the client device which new channel the access point will use before losing a connection. The access point and client can lose a connection for various reasons including, but not limited to, client inactivity or the client device moving out of the wireless range of the access point. For example a client device may be turned off due to inactivity and thus miss any update from the access point to move to another wireless channel. Therefore, the client device may scan all available channels to find the access point. Hence, given the increasing number of wireless channels, establishing a new connection between the client device and the access point may take an unacceptable length of time. Any delay in establishing a new connection may be particularly unacceptable in scenarios where real-time response is beneficial, such as in gaming scenarios.

This disclosure describes techniques for wireless communication. In particular, an access point may generate a schedule associated with a channel hop sequence to use in cases where the access point changes wireless channels. As used herein, a channel hop sequence refers to a sequence of wireless channels. For example, the channel hop sequence may be a pseudorandom ordering of available channels by which an access point can transmit data, wherein the pseudorandom ordering is based on an algorithm. In some examples, the order of the channel hop sequence can be based on the media access control (MAC) address of the access point. In some examples, a backup list can also be used, wherein the backup list includes a list of wireless channels that are more frequently used based on wireless metrics. For example, the access point (AP) may scan the list of wireless channels from the backup list first when scanning for an available channel. A client device, as used herein, refers to any computing device that can be wirelessly coupled to the access point. In some examples, the client device can be a wireless control, input device, or the like. In some embodiments, the AP can generate a seed used to generate the channel hop sequence. For example, the seed can be generated based on the MAC address of the access point. In some embodiments, the client device can generate the seed based on the MAC address of the access point and generate the channel hop sequence based on the seed.

The techniques thus reduce the time it takes for a wireless client to establish a new connection with an access point if the access point changed wireless channels. For example, the techniques allow client devices to avoid scanning channels that are unlikely to be used by the access point. In addition, the techniques herein enable constant-time rediscovery on average. For example, the discovery time is independent of the number of channels. Thus, the techniques can reduce the average time for rediscovery as compared to other methods. These techniques are described in more detail herein.

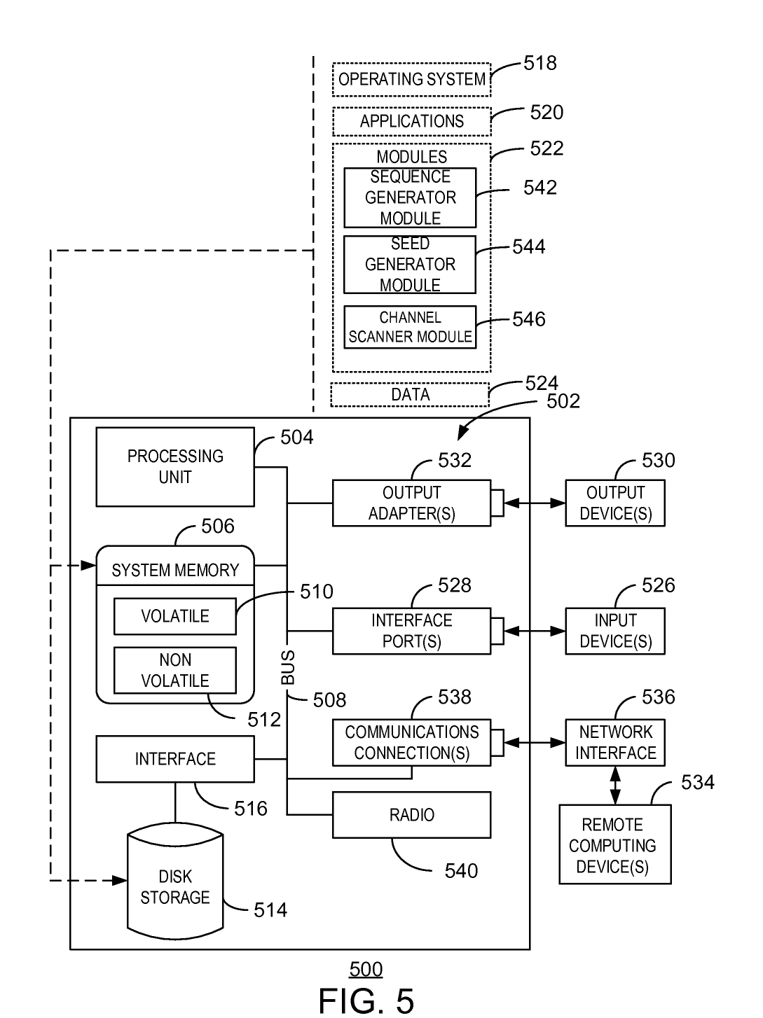

As a preliminary matter, some of the figures describe concepts in the context of one or more structural components, variously referred to as functionality, modules, features, elements, or the like. The various components shown in the figures can be implemented in any manner, such as software, hardware, firmware, or combinations thereof. In some cases, various components shown in the figures may reflect the use of corresponding components in an actual implementation. In other cases, any single component illustrated in the figures may be implemented by a number of actual components. The depiction of any two or more separate components in the figures may reflect different functions performed by a single actual component. FIG. 5, discussed below, provides details regarding one system that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into multiple component blocks, and certain blocks can be performed in an order that differs from that which is illustrated herein, including a parallel manner of performing the blocks. The blocks shown in the flowcharts can be implemented by software, hardware, firmware, manual processing, or the like. As used herein, hardware may include computer systems, discrete logic components, such as application specific integrated circuits (ASICs), or the like.

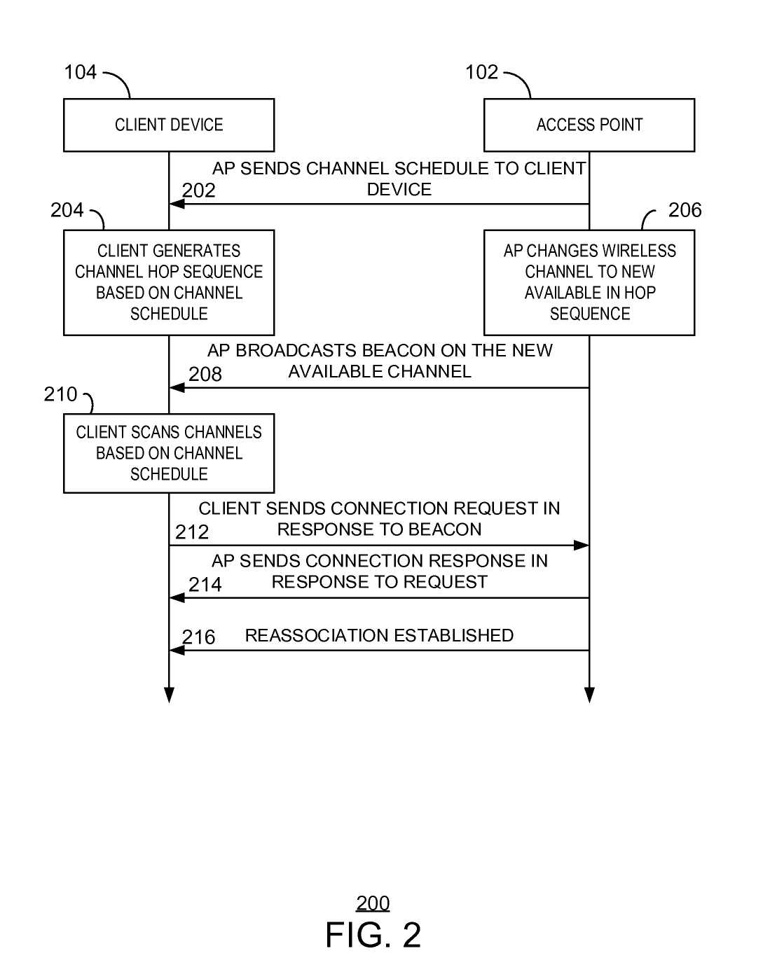

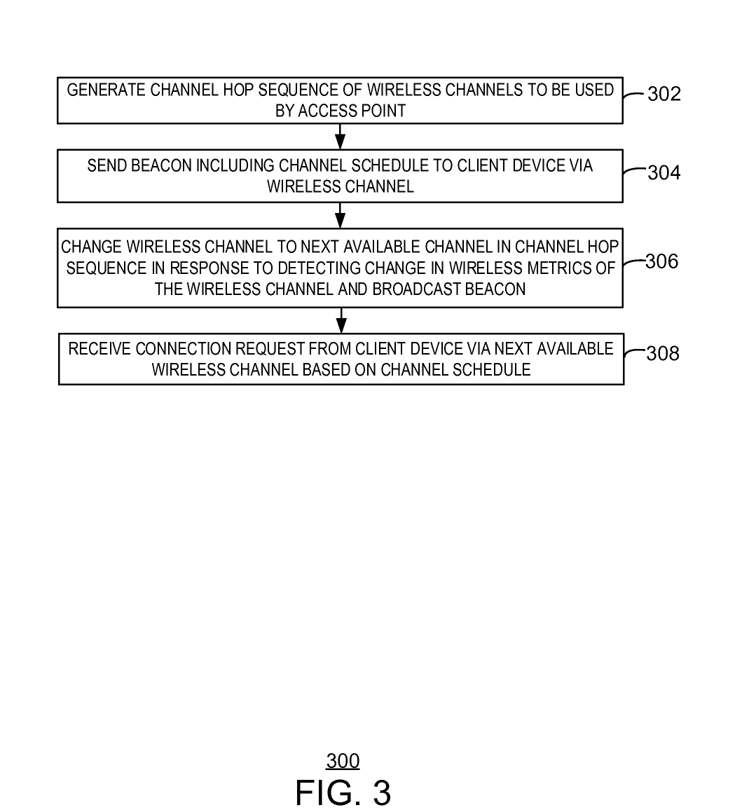

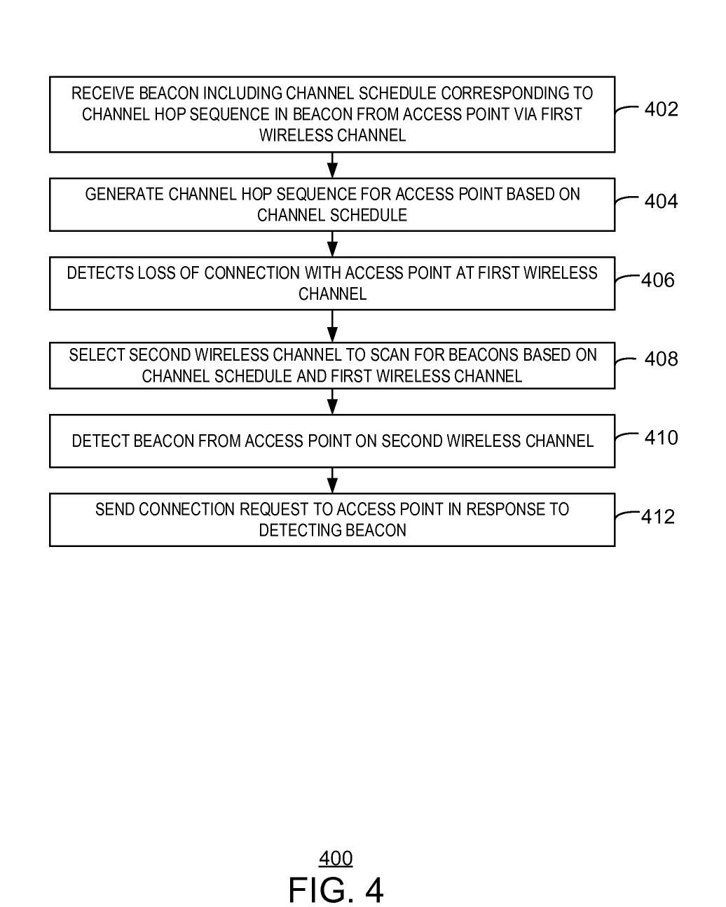

As to terminology, the phrase “configured to” encompasses any way that any kind of functionality can be constructed to perform an identified operation. The functionality can be configured to perform an operation using, for instance, software, hardware, firmware, or the like. For example, the phrase “configured to” can refer to a structure of an associated hardware element that can implement the associated functionality. The phrase “configured to” can also refer to the coding design of associated structural coding elements such as modules to implement the associated function of firmware or software. The term “module” refers to a structural element that can be implemented using any suitable hardware (e.g., a processor, among others), software (e.g., an application, among others), firmware, or any combination of hardware, software, and firmware. The term “logic” encompasses any functionality for performing a task. For instance, each operation illustrated in the timing diagram of FIG. 2 and flowcharts of FIGS. 3 and 4 corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the disclosed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media include magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may include communication media such as transmission media for wireless signals.

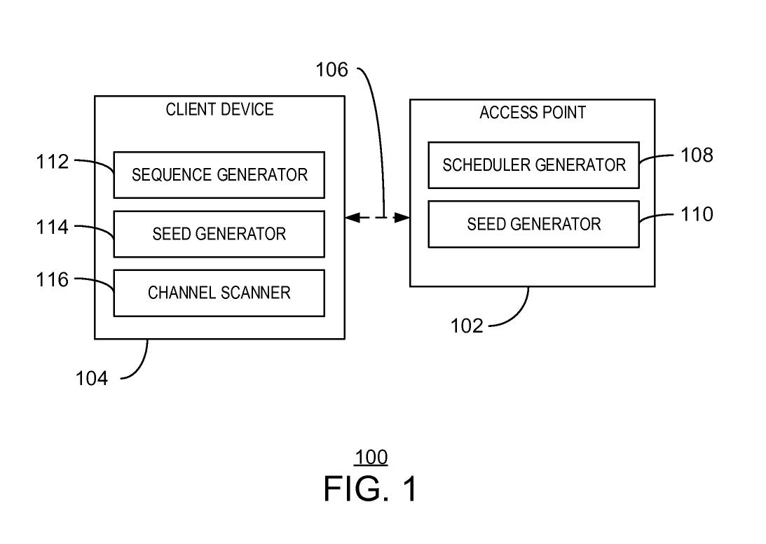

FIG. 1 is a block diagram of an example operating environment configured for implementing various aspects of the techniques described herein. The example operating environment of FIG. 1 is referred to generally by the reference number 100.

The example operating environment 100 includes an access point 102 and a client device 104 coupled via a wireless connection 106. The access point 102 includes a schedule generator 108 and a seed generator 110. The client device also includes a sequence generator 112 and a seed generator 114, in addition to a channel scanner 116.

In the example operating environment 100, the access point 102 may have any number of client devices coupled wirelessly including client device 104. For example, the access point 102 can be a gaming console and the client device 104 can be one of any number of wireless controllers.

The schedule generator 108 of access point 102 can generate a channel schedule for the access point 102 to use when changing wireless channels. For example, the channel schedule can correspond to a channel hop sequence that the access point 102 can use to discover an available wireless channel. In some examples, the channel hop sequence can be generated as m-sequences or using modulo-prime arithmetic. An m-sequence, or maximum length sequence, as used herein, refers to a pseudorandom binary sequence that can be generated using maximal linear feedback shift registers. Modulo-prime arithmetic, as used herein, refers to a technique to generate a pseudo number sequence that can be defined by the equation: x(n+1)=[x(n)+s] % p, where s is a “seed number” between 1 and p−1, and p is a prime number.

In some examples, the seed generator 110 of the access point 102 can generate a seed to use in generating the schedule and/or channel hop sequence as described in more detail with regard to FIG. 2 below. The seed can be included in a beacon sent to the client device 104 via wireless connection 106. For example, the access point may broadcast the beacon to all client devices nearby.

In some examples, in response to receiving the channel schedule in the beacon, the sequence generator 112 of the client device 104 can generate a channel hop sequence for the access point 102. For example, the channel schedule may include a pattern in which the access point 102 can change channels, or an algorithm that can be used to calculate the channel hop sequence. In some examples, the channel schedule can include a seed. For example, the sequence generator 112 can use the seed to generate the channel hop sequence. In some examples, the seed can be generated by the seed generator 114 of the client device 104 based on the MAC address of the access point 102. For example, the beacon from the access point 102 may also include the MAC address of the access point 102. In any case, once the sequence generator has generated the channel hop sequence, the channel scanner 116 of the client device 104 can use the channel hop sequence to scan wireless channels for beacons in response to the client device 104 losing a connection or association with the access point 102. For example, the channel scanner 116 can scan the wireless channels in the order of the channel hop sequence. In some examples, a backup list may also have been received with the channel schedule. For example, the schedule generator 108 of the access point 102 may have generated the backup list based on wireless metrics at the time of generation. The backup list can include an ordered list of channels that can be given priority in the channel hop sequence. The access point 102 may check to see whether the channels in the backup list are available before proceeding to check the channels in the channel hop sequence. Therefore, in some examples, the channel scanner 116 can be configured to scan the channels in the backup list before scanning the rest of the wireless channel possibilities according to the channel hop sequence. In some examples, the client device 104 may include a database of scanned channels that the channel scanner 116 can use to avoid scanning the same channel twice.

Upon detecting the beacon from the access point 102 on a new channel, the channel scanner 116 can return the new channel to the client device 104 to use in establishing a new connection with the access point 102. For example, the client device 104 can send a connection request in response to detecting the beacon via the new channel. The access point 102 can respond with a connection response, and the client 104 device can then be re-associated with the access point 102. Thus, the channel scanner 116 of the client device 104 may save both time and computing resources by scanning wireless channels according to the channel schedule generated by the schedule generator 108 of the access point 102.

The diagram of FIG. 1 is not intended to indicate that the example operating environment 100 is to include all of the components shown in FIG. 1. Rather, the example operating environment 100 can include fewer or additional components not illustrated in FIG. 1 (e.g., additional client devices, access points, wireless connections, etc.).

FIG. 2 is a timing diagram of an example process for wireless communication using channel schedules. The example process of FIG. 2 is referred to generally by the reference number 200.

The example process time line 200 includes a client device 104 and an access point 102. At time 202, the access point sends a channel schedule to the client device. For example, the channel schedule may correspond to a channel hop sequence that may have been generated using a seed. For example, a modulo-prime arithmetic technique may be used to generate a pseudorandom channel hop sequence using the seed. Given a total of N number of available wireless channels, a variable P can be defined as the smallest prime number greater than N. For example, if there are N=9 available channels, then P=11. The seed of the access point 102 can be a number between 1 and P−1. For example, the seed can be generated by using the equation:

(Σ MAC address digits) mod (P−1)+1,

wherein the MAC address digits refer to the MAC address digits of the access point 102 converted to decimal. In some examples, the client device 104 may similarly generate the seed based on the MAC address of the access point 102. Thus, less information may be broadcasted by the access point 102, saving time and resources. In some examples, the channel schedule may include the seed. In some examples, the access point can also send state information to the client device. For example, the state information can indicate a point in a channel hop sequence that the access point state corresponds to at a particular time.

At block 204, the client device 104 generates a channel hop sequence based on the channel schedule. For example, the client device 104 can generate the channel hop sequence using the seed. In some examples, the client device 104 can also record the channel that the access point 102 is currently using for later reference.

At block 206, the access point 102 changes its wireless channel to a next available channel in the channel hop sequence. For example, the access point 102 may change channels in response to detecting wireless interference, a priority device using the wireless channel, or for any other reason. The access point 102 can use the channel hop sequence to find an available channel by scanning through each channel in order. In response to detecting an available channel, the access point 102 may begin using the new available channel. Thus, at time 208, the access point 102 can broadcast a beacon on the new available channel.

In some examples, the access point 102 may have broadcasted a beacon on the previous wireless channel indicating the change of wireless channels. However, for any number of reasons, the client device 104 may have not received the broadcasted beacon indicating a change in channels. For example, the client device 104 may have been in a low power state due to inactivity or may have lost association due to interference, among other possible reasons.

At block 210 the client device 104 scans wireless channels based on the channel schedule. For example, the client device 104 can retrieve the last known wireless channel that the access point used, and use the channel hop sequence to determine the next channel that the access point could use. In some examples, a backup list of wireless channels may be scanned first, before scanning additional wireless channels according to the channel hop sequence. In some examples, the backup list can also be scanned according to the channel hop sequence. For example, the client device 104 can scan channels in the backup list that were used after the last known channel in the channel hop sequence.

The diagram of FIG. 2 is not intended to indicate that the example process 200 is to include all of the components shown in FIG. 2. Rather, the example process 200 can be implemented fewer or additional components not illustrated in FIG. 2 (e.g., additional client devices, access points, host devices, etc.). In one embodiment, the process of FIG. 2 is intended to indicate that the steps of the process 200 are to be executed in a particular order. Alternatively, in other embodiments, the steps of the process 200 can be executed in any suitable order and any suitable number of the steps of the process 200 can be included. Further, any number of additional steps may be included within the process 200, depending on the specific application.

FIG. 3 shows a process flow diagram of an example method for wireless communication using channel schedules. The example method is generally referred to by the reference number 300 and can be implemented using computer 502 as described below in relation to FIG. 5. The example method 300 can also be performed by the access point 102 of FIG. 1 described above.

At block 302, the access point can generate a channel hop sequence of wireless channels to be used by an access point. For example, the access point can generate the channel hop sequence using modulo-prime arithmetic as described above with regards to FIG. 2. In some examples, the access point can also generate the channel hop sequence using m-sequences. For example, the channel hop sequence can be a pseudorandom sequence of wireless channels. In some examples, the access point can use a seed to generate the channel hop sequence. For example, the seed can be based on the MAC address of the access point. In some examples, the access point can generate a backup list of channels based on channel metrics. For example, the backup list can be a set of wireless channels having channel metrics exceeding a predetermined threshold level of signal-to-interference-plus-noise-ratio (SINR).

At block 304, the access point can send a beacon including a channel schedule to a client device via a wireless channel. For example, the access point can broadcast the beacon to any client device within range of the access point. In some examples, the channel schedule can include the seed.

At block 306, the access point can change the wireless channel to a next available channel in the channel hop sequence in response to detecting a change in wireless metrics of the wireless channel and broadcast a beacon. For example, the SINR of the wireless channel may have dropped below a threshold SINR. The access point can scan a next wireless channel based on the channel hop sequence. If the wireless channel does not exceed a threshold SINR, then the access point can scan an additional wireless channel based on the channel hop sequence until a channel that exceeds the threshold SINR is detected. In some examples, any other suitable form of wireless channel metric may be used to detect an available channel. For example, wireless channel metrics such as packet loss, the number of access points on a channel, and the noise floor of a channel can be used to detect available channels. In some examples, the access point may continuously broadcast the beacon at predetermined intervals after changing the wireless channel to the available channel.

At block 308, the access point can receive a connection request from the client device via the next available wireless channel based on the channel schedule. For example, the client device may have detected the broadcasted beacon during scanning of wireless channels based on the channel hop sequence. The access point can then send a connection response and reestablish an association with the client device.

In one embodiment, the process flow diagram of FIG. 3 is intended to indicate that the steps of the method 300 are to be executed in a particular order. Alternatively, in other embodiments, the steps of the method 300 can be executed in any suitable order and any suitable number of the steps of the method 300 can be included. Further, any number of additional steps may be included within the method 300, depending on the specific application.

FIG. 4 shows a process flow diagram of an example method for wireless communication using channel schedules. The example method is generally referred to by the reference number 400 and can be implemented using computer 502 as described below in relation to FIG. 5. The example method 400 can also be performed by the client device of FIG. 1 described above.

At block 402, the client device can receive a beacon including a channel schedule corresponding to a channel hop sequence from an access point via a first wireless channel. In some examples, the client device can also receive a backup list. In some examples, the backup list can be part of the channel schedule. For example, the backup list can be a set of channels exceeding a threshold channel metric.

At block 404, the client device can generate a channel hop sequence for the access point based on the channel schedule. For example, the client device can generate the channel hop sequence based on the seed. In some examples, the client device can generate the seed based on a MAC address of the access point. For example, the client device can use any suitable algorithm to generate the seed, such as the algorithm described in FIG. 2 above.

At block 406, the client device can detect a loss of connection with the access point at the first wireless channel. For example, the client device may have been inactive and lost connection due to being placed into a low power state. In some examples, the client device may have lost connection with the access point due to wireless interference.

At block 408, the client device can select a second wireless channel to scan for beacons based on the channel schedule and the first wireless channel. In some examples, the second wireless channel may be in a backup list of channels to scan. For example, the backup list of channels may be scanned before other channels in the channel schedule. In some examples, the backup list of channels can be scanned based on the channel hop sequence and the first wireless channel. In some examples, additional channels can be scanned according to the channel hop sequence if the backup list of channels is not being used by the access point. In some examples, the client device can scan for beacons on channels based on the channel hop sequence and the first wireless channel.

At block 410, the client device can detect a beacon from the access point on the second wireless channel. For example, the access point may continuously broadcast the beacon at predetermined intervals. The client device can detect the beacon during the scan of the wireless channel the access point is using to broadcast the beacon.

At block 412, the client device can send a connection request to the access point in response to detecting the beacon. The access point can send a connection response and an association can be reestablished between the client device and the access point.

In one embodiment, the process flow diagram of FIG. 4 is intended to indicate that the steps of the method 400 are to be executed in a particular order. Alternatively, in other embodiments, the steps of the method 400 can be executed in any suitable order and any suitable number of the steps of the method 400 can be included. Further, any number of additional steps may be included within the method 400, depending on the specific application.

FIG. 5 is a block diagram of an example system for wireless communication using channel schedules. The example system 500 includes a computing device 502. The computing device 502 includes a processing unit 504, a system memory 506, and a system bus 508. For example, the computing device 502 may be the client device 104 of FIG. 1 above. In some examples, the computing device 502 can be a gaming console, a personal computer (PC), an accessory console, a gaming controller, among other computing devices. In some examples, the computing device 502 can be a node in a cloud network.

The system bus 508 couples system components including, but not limited to, the system memory 506 to the processing unit 504. The processing unit 504 can be any of various available processors. Dual microprocessors and other multiprocessor architectures also can be employed as the processing unit 504.

The system bus 508 can be any of several types of bus structure, including the memory bus or memory controller, a peripheral bus or external bus, and a local bus using any variety of available bus architectures known to those of ordinary skill in the art. The system memory 506 includes computer-readable storage media that includes volatile memory 510 and nonvolatile memory 512.

The basic input/output system (BIOS), containing the basic routines to transfer information between elements within the computer 502, such as during start-up, is stored in nonvolatile memory 512. By way of illustration, and not limitation, nonvolatile memory 512 can include read-only memory (ROM), programmable ROM (PROM), electrically programmable ROM (EPROM), electrically erasable programmable ROM (EEPROM), or flash memory.

Volatile memory 510 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 502 also includes other computer-readable media, such as removable/non-removable, volatile/non-volatile computer storage media. FIG. 5 shows, for example a disk storage 514. Disk storage 514 includes, but is not limited to, devices like a magnetic disk drive, floppy disk drive, tape drive, Jaz drive, Zip drive, LS-210 drive, flash memory card, or memory stick.

In addition, disk storage 514 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 514 to the system bus 508, a removable or non-removable interface is typically used such as interface 516.

It is to be appreciated that FIG. 5 describes software that acts as an intermediary between users and the basic computer resources described in the suitable operating environment 500. Such software includes an operating system 518. Operating system 518, which can be stored on disk storage 514, acts to control and allocate resources of the computer 502.

System applications 520 take advantage of the management of resources by operating system 518 through program modules 522 and program data 524 stored either in system memory 506 or on disk storage 514. It is to be appreciated that the disclosed subject matter can be implemented with various operating systems or combinations of operating systems.

A user enters commands or information into the computer 502 through input devices 526. Input devices 526 include, but are not limited to, a pointing device, such as, a mouse, trackball, stylus, and the like, a keyboard, a microphone, a joystick, a satellite dish, a scanner, a TV tuner card, a digital camera, a digital video camera, a web camera, and the like. In some examples, input devices 526 can include Natural User Interface (NUI) devices. NUI refers to any interface technology that enables a user to interact with a device in a “natural” manner, free from artificial constraints imposed by input devices such as mice, keyboards, remote controls, and the like. In some examples, NUI devices include devices relying on speech recognition, touch and stylus recognition, gesture recognition both on screen and adjacent to the screen, air gestures, head and eye tracking, voice and speech, vision, touch, gestures, and machine intelligence. For example, NUI devices can include touch sensitive displays, voice and speech recognition, intention and goal understanding, and motion gesture detection using depth cameras such as stereoscopic camera systems, infrared camera systems, RGB camera systems and combinations of these. NUI devices can also include motion gesture detection using accelerometers or gyroscopes, facial recognition, three-dimensional (3D) displays, head, eye, and gaze tracking, immersive augmented reality and virtual reality systems, all of which provide a more natural interface. NUI devices can also include technologies for sensing brain activity using electric field sensing electrodes. For example, a NUI device may use Electroencephalography (EEG) and related methods to detect electrical activity of the brain. In some examples, the client device of FIG. 1 may be an input device 526. The input devices 526 connect to the processing unit 504 through the system bus 505 via interface ports 528. Interface ports 528 include, for example, a serial port, a parallel port, a game port, and a universal serial bus (USB).

Output devices 530 use some of the same type of ports as input devices 526. Thus, for example, a USB port may be used to provide input to the computer 502, and to output information from computer 502 to an output device 530.

Output adapter 532 is provided to illustrate that there are some output devices 530 like monitors, speakers, and printers, among other output devices 530, which are accessible via adapters. The output adapters 532 include, by way of illustration and not limitation, video and sound cards that provide a means of connection between the output device 530 and the system bus 508. It can be noted that other devices and systems of devices provide both input and output capabilities such as remote computing devices 534.

The computer 502 can be a server hosting various software applications in a networked environment using logical connections to one or more remote computers, such as remote computing devices 534. The remote computing devices 534 may be client systems configured with web browsers, PC applications, mobile phone applications, and the like. The remote computing devices 534 can be a personal computer, a server, a router, a network PC, a workstation, a microprocessor based appliance, a mobile phone, a peer device or other common network node and the like, and typically includes many or all of the elements described relative to the computer 502.

Remote computing devices 534 can be logically connected to the computer 502 through a network interface 536 and then connected via a communication connection 538, which may be wireless. Network interface 536 encompasses wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection 538 refers to the hardware/software employed to connect the network interface 536 to the bus 508. While communication connection 538 is shown for illustrative clarity inside computer 502, it can also be external to the computer 502. The hardware/software for connection to the network interface 536 may include, for exemplary purposes, internal and external technologies such as, mobile phone switches, modems including regular telephone grade modems, cable modems and DSL modems, ISDN adapters, and Ethernet cards.

The computer 502 can further include a radio 540. For example, the radio 540 may be any suitable wireless local area network radio, among other suitable wireless network radios.

An example processing unit 504 for the server may be a computing cluster. Additionally, the disk storage 514 can store various types of data 524 used for generating channel hop sequences. For example, the disk storage 514 may be an enterprise data storage system. In some examples, the disk storage 514 may store data 524 such as a channel schedule, access point MAC addresses, and scanned channels.

The computer 502 includes one or more modules 522 configured to enable wireless communication, including a sequence generator module 542, a seed generator module 544, and a channel scanner module 546. The generator module 542, seed generator module 544, and channel scanner module 546, refer to structural elements that perform associated functions. In some embodiments, the functionalities of the generator module 542, seed generator module 544, and channel scanner module 546, can be implemented with logic, wherein the logic, as referred to herein, can include any suitable hardware (e.g., a processor, among others), software (e.g., an application, among others), firmware, or any combination of hardware, software, and firmware. The sequence generator module 542 can receive a beacon including a channel schedule corresponding to a channel hop sequence from an access point via a first wireless channel. For example, the beacon can also include, among other things, the MAC address of the access point and a seed. In some examples, the beacon can also include a backup list of wireless channels. For example, the channels in the backup list may have exceeded a wireless metric threshold. For example, the wireless metric threshold can be a threshold SINR value. The sequence generator module 542 can generate a channel hop sequence for the access point based on the channel schedule. In some examples, the sequence generator module 542 can generate the hop sequence based on a seed. For example, the seed may have been received from the access point in the beacon. In some examples, the seed generator 544 module can generate the seed. For example, the seed generator 544 can generate the seed based on the MAC address of the access point. The channel scanner module 546 can detect a loss of connection with the access point at the first wireless channel. For example, the access point may have lost association with the client device and subsequently changed wireless channels. The channel scanner module 546 can further select a second wireless channel to scan for beacons based on the channel schedule and the first wireless channel. For example, the channel scanner module 546 can select the second wireless channel to scan based on the channel hop sequence generated by the sequence generator module 542. In some examples, the channel scanner module 546 can scan the backup list of wireless channels before scanning channel based on the channel hop sequence. In some examples, the channel scanner module 546 can scan the backup list based on the channel hop sequence and the first wireless channel. For example, the channels in the backup list can be scanned in the order that they appear in the channel hop sequence.

It is to be understood that the block diagram of FIG. 5 is not intended to indicate that the computing system 500 is to include all of the components shown in FIG. 5. Rather, the computing system 500 can include fewer or additional components not illustrated in FIG. 5 (e.g., additional applications, additional modules, additional memory devices, additional network interfaces, additional radios, etc.). Furthermore, any of the functionalities of the sequence generator module 542, the seed generator module 544, or the channel scanner module 546, can be partially, or entirely, implemented in hardware and/or in a processor. For example, the functionality can be implemented with an application specific integrated circuit, in logic implemented in the processor, or in any other device. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), and Complex Programmable Logic Devices (CPLDs), etc.

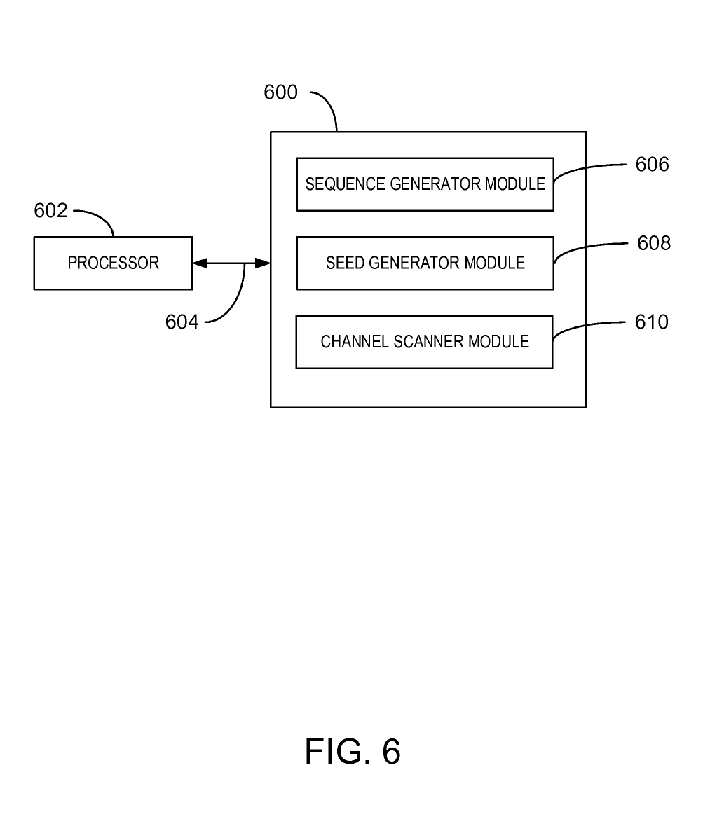

FIG. 6 is a block diagram showing an example tangible, computer-readable storage medium that can be used for wireless communication using channel schedules. The tangible, computer-readable storage media 600 can be accessed by a processor 602 over a computer bus 604. Furthermore, the tangible, computer-readable storage media 600 can include code to direct the processor 602 to perform the current methods.

The various software components discussed herein can be stored on the tangible, computer-readable storage media 600, as indicated in FIG. 6. For example, the tangible computer-readable storage media 600 can include a sequence generator module 606, a seed generator module 608, and a channel scanner module 610. The sequence generator module 606, seed generator module 608, and channel scanner module 610, refer to structural elements that perform associated functions. In some embodiments, the functionalities of the sequence generator module 606, seed generator module 608, and channel scanner module 610, can be implemented with logic, wherein the logic, as referred to herein, can include any suitable hardware (e.g., a processor, among others), software (e.g., an application, among others), firmware, or any combination of hardware, software, and firmware. In some implementations, the sequence generator module 606 can receive a beacon including a channel schedule corresponding to a channel hop sequence from an access point via a first wireless channel. For example, the beacon can also include, among other things, the MAC address of the access point and a seed. In some examples, the beacon can also include a backup list of wireless channels. For example, the channels in the backup list may have exceeded a wireless metric threshold. For example, the wireless metric threshold can be a threshold SINR value. The sequence generator module 606 can generate a channel hop sequence for the access point based on the channel schedule. In some examples, the sequence generator module 606 can generate the hop sequence based on a seed. For example, the seed may have been received from the access point in the beacon. In some examples, the seed generator 608 module can generate the seed. For example, the seed generator 608 can generate the seed based on the MAC address of the access point. The channel scanner module 610 can detect a loss of connection with the access point at the first wireless channel. For example, the access point may have lost association with the client device and subsequently changed wireless channels. The channel scanner module 610 can further select a second wireless channel to scan for beacons based on the channel schedule and the first wireless channel. For example, the channel scanner module 610 can select the second wireless channel to scan based on the channel hop sequence generated by the sequence generator module 606. In some examples, the channel scanner module 610 can scan the backup list of wireless channels before scanning channel based on the channel hop sequence. In some examples, the channel scanner module 610 can scan the backup list based on the channel hop sequence and the first wireless channel. For example, the channel scanner module 610 can scan the channels in the backup list in the order that they appear in the channel hop sequence.

It is to be understood that any number of additional software components not shown in FIG. 6 can be included within the tangible, computer-readable storage media 600, depending on the specific application. Although the subject matter has been described in language specific to structural features and/or methods, it is to be understood that the subject matter defined in the appended claims is not necessarily limited to the specific structural features or methods described above. Rather, the specific structural features and methods described above are disclosed as example forms of implementing the claims.

### Example 1

This example provides for an example system for wireless communication. The example system includes a processor and a computer-readable memory storage device storing executable instructions that, based on an execution by the processor, cause the processor to generate a channel hop sequence of wireless channels to be used by an access point. The instructions also cause the processor to send a beacon including a channel schedule to a client device via a wireless channel. The instructions also cause the processor to change the wireless channel to a next available channel in the channel hop sequence in response to detecting a change in wireless metrics of the wireless channel. The instructions further cause the processor to receive a connection request from the client device via the next available wireless channel based at least on the channel schedule. Alternatively, or in addition, the channel hop sequence may be a pseudorandom sequence. Alternatively, or in addition, the channel schedule may include the channel hop sequence. Alternatively, or in addition, the channel schedule may include a seed corresponding to the channel hop sequence. Alternatively, or in addition, the processor may further generate the seed corresponding to the channel hop sequence of the access point. Alternatively, or in addition, the processor may generate the channel hop sequence based at least on a media access control (MAC) address of the access point. Alternatively, or in addition, the processor may further send a backup list of wireless channels to the client device. Alternatively, or in addition, the backup list may include a plurality of wireless channels based at least on channel metrics. Alternatively, or in addition, the processor may generate the channel hop sequence using m-sequences or modulo-prime arithmetic.

### Example 2

This example provides for an example system for wireless communication. The example system includes a processor and a computer-readable memory storage device storing executable instructions that, based on an execution by the processor, cause the processor to receive a first beacon including a channel schedule corresponding to a channel hop sequence from an access point via a first wireless channel. The instructions also cause the processor to generate a channel hop sequence for the access point based at least on the channel schedule. The instructions further cause the processor to detect a loss of connection with the access point at the first wireless channel. The instructions also cause the processor to select a second wireless channel to scan for beacons based at least on the channel schedule and the first wireless channel. The instructions further cause the processor to detect a second beacon from the access point on the second wireless channel. The instructions further also cause the processor to send a connection request to the access point on the second wireless channel in response to detecting the second beacon. Alternatively, or in addition, the processor may further monitor the second wireless channel in response to sending the connection request. Alternatively, or in addition, the processor may further detect that the access point stops transmitting the second beacon via the second wireless channel. Alternatively, or in addition, the processor may further select an additional wireless channel from the channel hop sequence. Alternatively, or in addition, the processor may further send a second connection request to the access point via the additional wireless channel in response to detecting a beacon transmitted by the access point via the additional wireless channel. Alternatively, or in addition, the channel hop sequence may include a pseudorandom sequence generated based at least on a MAC address of the access point. Alternatively, or in addition, the channel schedule may include the channel hop sequence. Alternatively, or in addition, the channel schedule may include a seed corresponding to the channel hop sequence. Alternatively, or in addition, the processor may generate the channel hop sequence based at least on the seed. Alternatively, or in addition, the channel schedule may include a backup list of available channels from the access point. Alternatively, or in addition, the processor may select the second wireless channel from the backup list of available channels based at least on the channel schedule and the first wireless channel. Alternatively, or in addition, the channel schedule may include a backup list of available channels from the access point. Alternatively, or in addition, the backup list may include the second channel. Alternatively, or in addition, the channel schedule may include a backup list of available channels from the access point. Alternatively, or in addition, the processor may scan the backup list of available channels for the beacon from the access point before the processor is to select the second wireless channel from the channel hop sequence.

### Example 3

This example provides for an example method for wireless communication. The example method includes receiving a beacon including a channel schedule corresponding to a channel hop sequence in a beacon from an access point via a first wireless channel. The example method includes generating a channel hop sequence for the access point based at least on the channel schedule. The example method also includes detecting a loss of connection with the access point at the first wireless channel. The example method further includes selecting a second wireless channel to scan for beacons based at least on the channel schedule and the first wireless channel. The example method also includes detecting a beacon from the access point on the second wireless channel. The example method further also includes sending a connection request via the second wireless channel to the access point in response to detecting the beacon. Alternatively, or in addition, the example method may include scanning a backup list of available channels for the beacon from the access point. Alternatively, or in addition, the backup list of available channels may include the second wireless channel. Alternatively, or in addition, the channel schedule may include the backup list of available channels. Alternatively, or in addition, the example method may also include scanning a backup list of available channels for the beacon from the access point based at least on the channel hop sequence and the first wireless channel. Alternatively, or in addition, the example method may include scanning a backup list of available channels for the beacon from the access point based at least on the channel hop sequence and selecting the second wireless channel from the backup list of available channels in response to detecting the beacon. Alternatively, or in addition, the example method may include scanning a backup list of available channels for the beacon from the access point before selecting the second wireless channel based at least on the channel hop sequence and the first wireless channel.

### Example 4

This example provides for an example one or more computer-readable memory storage devices for storing computer readable instructions that, when executed by one or more processing devices, instruct wireless communication. The computer-readable instructions may include code to receive a beacon including a channel schedule corresponding to a channel hop sequence from an access point via a first wireless channel. The computer-readable instructions may include code to generate a channel hop sequence for the access point based at least on the channel schedule. The computer-readable instructions may include code to detect a loss of connection with the access point at the first wireless channel. The computer-readable instructions may include code to select a second wireless channel to scan for beacons based at least on the channel schedule and the first wireless channel. Alternatively, or in addition the beacon may include a MAC address of the access point and a seed. Alternatively, or in addition, the beacon may also include a backup list of wireless channels. Alternatively, or in addition, the channels in the backup list may have exceeded a wireless metric threshold. Alternatively, or in addition, the wireless metric threshold may be a threshold signal-to-interference-plus-noise-ratio (SINR) value. Alternatively, or in addition, the computer-readable instructions may include code to generate the hop sequence based at least on a seed. Alternatively, or in addition, the seed may have been received from the access point in the beacon. Alternatively, or in addition, the computer-readable instructions may include code to generate the seed. Alternatively, or in addition, the computer-readable instructions may include code to generate the seed based at least on the MAC address of the access point. Alternatively, or in addition, the computer-readable instructions may include code to select the second wireless channel to scan based at least on the generated channel hop sequence. Alternatively, or in addition, the computer-readable instructions may include code to scan the backup list of wireless channels before scanning channel based at least on the channel hop sequence. Alternatively, or in addition, the computer-readable instructions may include code to scan the backup list based at least on the channel hop sequence and the first wireless channel. Alternatively, or in addition, the computer-readable instructions may include code to scan the channels in the backup list in the order that they appear in the channel hop sequence.

### Example 5

This example provides for an example system for wireless communication. The example system includes means for generating a channel hop sequence of wireless channels to be used by an access point. The example system includes means for sending a beacon including a channel schedule to a client device via a wireless channel. The example system includes means for changing the wireless channel to a next available channel in the channel hop sequence in response to detecting a change in wireless metrics of the wireless channel. The example system includes means for receiving a connection request from the client device via the next available wireless channel based at least on the channel schedule. Alternatively, or in addition, the channel hop sequence may be a pseudorandom sequence. Alternatively, or in addition, the channel schedule may include the channel hop sequence. Alternatively, or in addition, the channel schedule may include a seed corresponding to the channel hop sequence. Alternatively, or in addition, the example system may include means for generating the seed corresponding to the channel hop sequence of the access point. Alternatively, or in addition, the example system may include means for generating the channel hop sequence based at least on a media access control (MAC) address of the access point. Alternatively, or in addition, the example system may include means for sending a backup list of wireless channels to the client device. Alternatively, or in addition, the backup list may include a plurality of wireless channels based at least on channel metrics. Alternatively, or in addition, the example system may include means for generating the channel hop sequence using m-sequences or modulo-prime arithmetic.

### Example 6

This example provides for an example system for wireless communication. The example system includes means for receiving a first beacon including a channel schedule corresponding to a channel hop sequence from an access point via a first wireless channel. The example system also includes means for generating a channel hop sequence for the access point based at least on the channel schedule. The example system also includes means for detecting a loss of connection with the access point at the first wireless channel. The example system also includes means for selecting a second wireless channel to scan for beacons based at least on the channel schedule and the first wireless channel. The example system also includes means for detecting a second beacon from the access point on the second wireless channel. The example system also includes means for sending a connection request to the access point on the second wireless channel in response to detecting the second beacon. Alternatively, or in addition, the example system may include means for monitoring the second wireless channel in response to sending the connection request. Alternatively, or in addition, the example system may include means for detecting that the access point stops transmitting the second beacon via the second wireless channel. Alternatively, or in addition, the example system may include means for selecting an additional wireless channel from the channel hop sequence. Alternatively, or in addition, the example system may include means for sending a second connection request to the access point via the additional wireless channel in response to detecting a beacon transmitted by the access point via the additional wireless channel. Alternatively, or in addition, the channel hop sequence may include a pseudorandom sequence generated based at least on a MAC address of the access point. Alternatively, or in addition, the channel schedule may include the channel hop sequence. Alternatively, or in addition, the channel schedule may include a seed corresponding to the channel hop sequence. Alternatively, or in addition, the example system may include means for generating the channel hop sequence based at least on the seed. Alternatively, or in addition, the channel schedule may include a backup list of available channels from the access point. Alternatively, or in addition, the example system may include means for selecting the second wireless channel from the backup list of available channels based at least on the channel schedule and the first wireless channel. Alternatively, or in addition, the channel schedule may include a backup list of available channels from the access point. Alternatively, or in addition, the backup list may include the second channel. Alternatively, or in addition, the channel schedule may include a backup list of available channels from the access point. Alternatively, or in addition, the example system may include means for scanning the backup list of available channels for the beacon from the access point before the processor is to select the second wireless channel from the channel hop sequence.

What has been described above includes examples of the disclosed subject matter. It is, of course, not possible to describe every conceivable combination of components or methodologies for purposes of describing the disclosed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the disclosed subject matter. In this regard, it will also be recognized that the innovation includes a system as well as a computer-readable storage media having computer-executable instructions for performing the acts and events of the various methods of the disclosed subject matter.

There are multiple ways of implementing the disclosed subject matter, e.g., an appropriate API, tool kit, driver code, operating system, control, standalone or downloadable software object, etc., which enables applications and services to use the techniques described herein. The disclosed subject matter contemplates the use from the standpoint of an API (or other software object), as well as from a software or hardware object that operates according to the techniques set forth herein. Thus, various implementations of the disclosed subject matter described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the disclosed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system for wireless communication, comprising:
a processor; and
a computer-readable memory storage device storing executable instructions that, based on an execution by the processor, cause the processor to:
generate a channel hop sequence of wireless channels to be used by an access point;
send a beacon comprising a channel schedule to a client device via a wireless channel;
change the wireless channel to a next available channel in the channel hop sequence in response to detecting a change in wireless metrics of the wireless channel; and
receive a connection request from the client device via the next available wireless channel based at least on the channel schedule.

2. The system of claim 1, wherein the channel hop sequence comprises a pseudorandom sequence.

3. The system of claim 1, wherein the channel schedule comprises the channel hop sequence.

4. The system of claim 3, wherein the channel schedule comprises a seed corresponding to the channel hop sequence, wherein the processor is to further generate the seed corresponding to the channel hop sequence of the access point.

5. The system of claim 4, wherein the processor is to generate the channel hop sequence based at least on a media access control (MAC) address of the access point.

6. The system of claim 1, wherein the processor is to further send a backup list of wireless channels to the client device, wherein the backup list comprises a plurality of wireless channels based at least on channel metrics.

7. The system of claim 1, wherein the processor is to generate the channel hop sequence using m-sequences or modulo-prime arithmetic.

8. A system for wireless communication, comprising:
a processor; and
a computer-readable memory storage device storing executable instructions that, based on an execution by the processor, cause the processor to:
receive a first beacon comprising a channel schedule corresponding to a channel hop sequence from an access point via a first wireless channel;
generate a channel hop sequence for the access point based at least on the channel schedule;
detect a loss of connection with the access point at the first wireless channel;
select a second wireless channel to scan for beacons based at least on the channel schedule and the first wireless channel;
detect a second beacon from the access point on the second wireless channel; and
send a connection request to the access point on the second wireless channel in response to detecting the second beacon.

9. The system of claim 8, wherein the processor is to further:
monitor the second wireless channel in response to sending the connection request;
detect that the access point stops transmitting the second beacon via the second wireless channel;
select an additional wireless channel from the channel hop sequence; and
send a second connection request to the access point via the additional wireless channel in response to detecting a beacon transmitted by the access point via the additional wireless channel.

10. The system of claim 8, wherein the channel hop sequence comprises a pseudorandom sequence generated based at least on a MAC address of the access point.

11. The system of claim 8, wherein the channel schedule comprises the channel hop sequence.

12. The system of claim 11, wherein the channel schedule comprises a seed corresponding to the channel hop sequence, wherein the processor is to generate the channel hop sequence based at least on the seed.

13. The system of claim 8, wherein the channel schedule comprises a backup list of available channels from the access point, and wherein the processor is to select the second wireless channel from the backup list of available channels based at least on the channel schedule and the first wireless channel.

14. The system of claim 8, wherein the channel schedule comprises a backup list of available channels from the access point, and wherein the backup list comprises the second channel.

15. The system of claim 8, wherein the channel schedule comprises a backup list of available channels from the access point, and wherein the processor is to scan the backup list of available channels for the beacon from the access point before the processor is to select the second wireless channel from the channel hop sequence.

16. A method for wireless communication, comprising:
receiving a beacon comprising a channel schedule corresponding to a channel hop sequence in a beacon from an access point via a first wireless channel;
generating a channel hop sequence for the access point based at least on the channel schedule;
detecting a loss of connection with the access point at the first wireless channel;
selecting a second wireless channel to scan for beacons based at least on the channel schedule and the first wireless channel;
detecting a beacon from the access point on the second wireless channel; and
sending a connection request via the second wireless channel to the access point in response to detecting the beacon.

17. The method of claim 16, further comprising scanning a backup list of available channels for the beacon from the access point, wherein the backup list of available channels comprises the second wireless channel, and wherein the channel schedule comprises the backup list of available channels.

18. The method of claim 16, further comprising scanning a backup list of available channels for the beacon from the access point based at least on the channel hop sequence and the first wireless channel, wherein the backup list of available channels comprises the second wireless channel, and wherein the channel schedule comprises the backup list of available channels.

19. The method of claim 16, further comprising scanning a backup list of available channels for the beacon from the access point based at least on the channel hop sequence and selecting the second wireless channel from the backup list of available channels in response to detecting the beacon.

20. The method of claim 16, further comprising scanning a backup list of available channels for the beacon from the access point before selecting the second wireless channel based at least on the channel hop sequence and the first wireless channel.
